(19) United States
(12) Patent Application Publication
(10) Pub. No.: US 2015/0325179 A1
(43) Pub. Date: Nov. 12, 2015

(54) IMAGE DISPLAY SYSTEM FOR DISPLAYING IMAGE INCLUDING OBJECT IMAGE, IMAGE DISPLAY APPARATUS, IMAGE OUTPUT APPARATUS, AND IMAGE DISPLAY METHOD

(71) Applicant: CANON KABUSHIKI KAISHA, Tokyo (JP)

(72) Inventor: Yoshikazu Shibamiya, Tokyo (JP)

(21) Appl. No.: 14/707,870

(22) Filed: May 8, 2015

(30) Foreign Application Priority Data
May 12, 2014 (JP) 2014-098453

(51) Int. Cl. G09G 3/34; G09G 3/36

(52) U.S. Cl. CPC G09G 3/3426; G09G 3/3666; G09G 2320/0238; G09G 2320/0626

(57) ABSTRACT

An image display system, which displays an image including an object image, includes a background region detection unit configured to detect a background image region, which does not include the object image, in the display image, an accompanying image generation unit configured to detect an accompanying image region including an accompanying image displayed in association with the display image, a display unit configured to display the display image, a light emission unit configured to be capable of changing light emission brightness corresponding to a plurality of divided regions in the display unit, a controller configured to control the light emission brightness in the plurality of divided regions in accordance with the background image region, and a brightness correction unit configured to correct a brightness value of at least a first portion of the accompanying image included in the background image region in accordance with at least the accompanying image region.

### BACKGROUND OF THE INVENTION

1. Field of the Invention

The present inventions relate to at least one image display system which displays an image including an object image, at least one image display apparatus, at least one image output apparatus, at least one image display method, one or more methods for using the system(s) and apparatus(es) and one or more computer-readable storage mediums.

2. Description of the Related Art

Liquid crystal panels used in liquid crystal display apparatuses display images by controlling transmittance of light emitted from backlights. As a method for preventing black floating which is a phenomenon in which reproducibility of black is degraded due to leakage of light emitted from a backlight from a liquid crystal panel, a local dimming (LD) process of controlling light emission brightness of the backlight in accordance with an image signal has been widely used. In the local dimming process, a screen of a liquid crystal panel is divided into a plurality of regions and light emission brightness of a backlight is reduced in a unit of region so that brightness of image data is corrected in accordance with an amount of the reduction of the light emission brightness. Japanese Patent Laid-Open No. 2012-242672 discloses a liquid crystal display apparatus which performs local dimming so that brightness of a backlight becomes uniform in a region including an OSD (On Screen Display) image, such as a menu window.

Medical images generated by medical devices include black background image regions surrounding diagnostic images to be diagnosed by doctors in many cases. In a case where such a medical image is displayed in a liquid crystal display apparatus, the black floating is prevented from being generated by reducing light emission brightness of a backlight (BL) in a background image region using the local dimming technique so that a diagnostic image is easily viewed.

However, in a case where boundary lines representing a boundaries between a plurality of medical images, a title bar used to check an operation method and a status, and the like are included in the background image region, portions corresponding to the boundary lines and the title bar are not recognized as the background image region, and therefore, a process of reducing the light emission brightness of the backlight is not performed. Therefore, a region having high light emission brightness of the backlight is generated in the vicinity of a diagnostic image. Accordingly, when a region having high light emission brightness of the backlight is positioned in the vicinity of the diagnostic image, it is difficult for a doctor to concentrate on analysis of the diagnostic image.

However, in a case where light emission brightness of a backlight in a background image region including a boundary line and a title bar is uniformly reduced by setting portions of the boundary line and the title bar as the background image region, visibility of the boundary line and the title bar are degraded. For example, in a case where a title bar including a character string representing content of a diagnostic image overlaps with a background image region, when light emission brightness of the backlight is low in a region including the character string, it is difficult for a doctor who analyzes the diagnostic image to read the character string.

### SUMMARY OF THE INVENTION

At least one embodiment of an image display system according to the present inventions displays a display image including an object image. The image display system includes a first detection unit configured to detect a background image region, which does not include the object image, in the display image, a second detection unit configured to detect an accompanying image region including an accompanying image displayed in association with the display image, a display unit configured to display the display image, a light emission unit configured to be capable of changing light emission brightness corresponding to a plurality of divided regions in the display unit, a controller configured to control the light emission brightness in the plurality of divided regions in accordance with the background image region, and a brightness correction unit configured to correct a brightness value of at least a first portion of the accompanying image included in the background image region in accordance with at least the accompanying image region.

According to other aspects of the present inventions, one or more additional image display systems, one or more additional image display apparatuses, one or more additional image output apparatuses, one or more methods for using same, one or more additional image display methods and one or more computer-readable storage mediums are discussed herein. Further features of the present inventions will become apparent from the following description of exemplary embodiments with reference to the attached drawings.

### BRIEF DESCRIPTION OF THE DRAWINGS

FIG. 1 is a diagram illustrating a configuration of an image display system according to a first embodiment.

FIG. 2 is a diagram illustrating an image displayed by an image display apparatus according to the first embodiment.

FIG. 3 is a diagram illustrating configurations of an image output apparatus and an image display apparatus.

FIGS. 4A and 4B are diagrams illustrating an accompanying image and a background image, respectively.

FIG. 5 is a diagram illustrating BL divided regions.

FIGS. 6A and 6B are diagrams illustrating a light emission brightness reduction region.

FIGS. 7A to 7C are diagrams illustrating an effect of correction of brightness of the accompanying image.

FIG. 8 is a flowchart illustrating a procedure of an operation of the image output apparatus according to the first embodiment.

FIG. 9 is a flowchart illustrating a procedure of an operation of the image display apparatus according to the first embodiment.

FIG. 10 is a diagram illustrating configurations of an image output apparatus and an image display apparatus according to a second embodiment.

FIG. 11 is a flowchart illustrating a procedure of an operation of the image output apparatus according to the second embodiment.

FIG. 12 is a flowchart illustrating a procedure of an operation of the image display apparatus according to the second embodiment.

FIG. 13 is a diagram illustrating configurations of an image output apparatus and an image display apparatus according to a third embodiment.

### DESCRIPTION OF THE EMBODIMENTS

### First Embodiment

### Image Display System 1

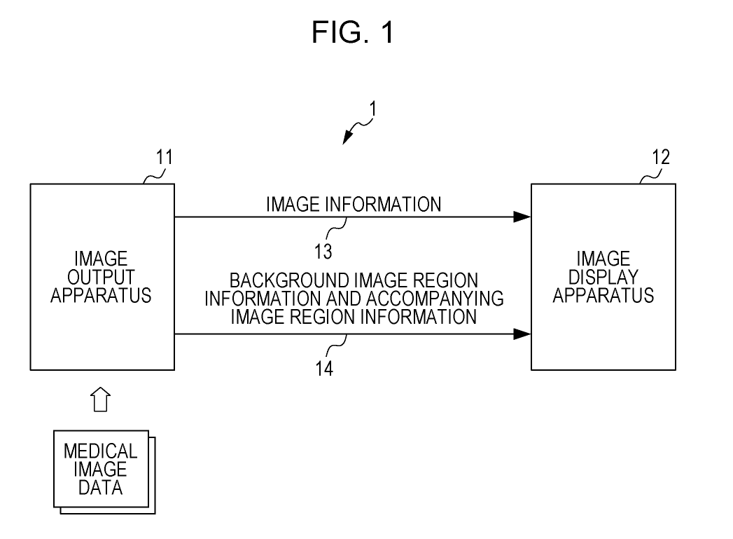

FIG. 1 is a diagram illustrating a configuration of an image display system 1 according to a first embodiment.

The image display system 1 includes an image output apparatus 11 and an image display apparatus 12. The image output apparatus 11 is a computer capable of outputting images and stores medical image data obtained from medical devices capable of capturing sectional images of CT (Computed Tomography), MRI (Magnetic Resonance Imaging), and the like. The image display apparatus 12 is a display capable of displaying medical images based on the medical image data stored in the image output apparatus 11. The image display apparatus 12 is a liquid crystal display including a backlight, for example.

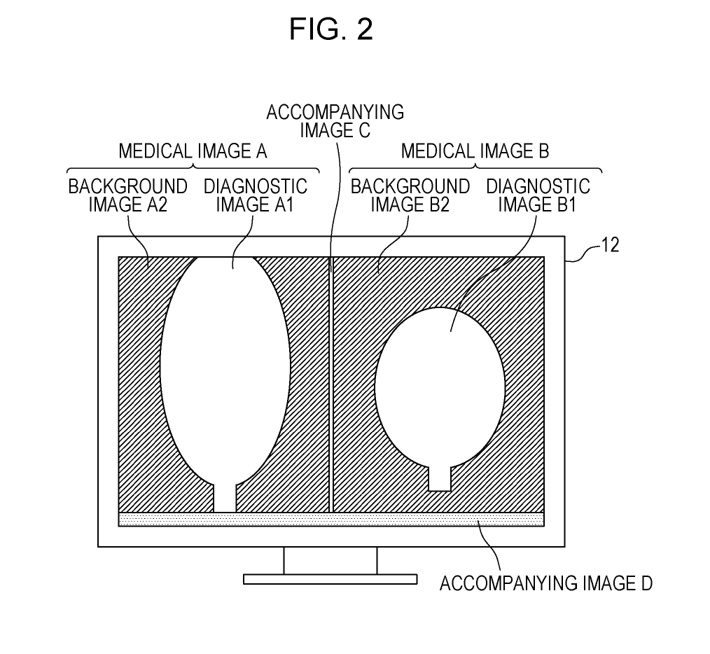

FIG. 2 is a diagram illustrating an image displayed in the image display apparatus 12. In FIG. 2, a medical image including a diagnostic image serving as an image of an object displayed in the display and an image of background of the diagnostic image is illustrated as an example of a display image. In FIG. 2, an accompanying image which is associated with the display image is displayed. The accompanying image corresponds to an image of a boundary line for facilitating discrimination of boundaries between a plurality of medical images when various GUI (Graphical User Interface) images, such as a title bar, an operation panel, and a window, required for operation of displaying and viewing the diagnostic image and the plurality of medical images are displayed.

In FIG. 2, medical images A and B are illustrated. The medical image A includes a diagnostic image A1 and a black background image A2 (hatched in FIG. 2). The medical image B includes a diagnostic image B1 and a black background image B2. An accompanying image C representing a boundary between the medical images A and B is displayed between the medical images A and B. Furthermore, an accompanying image D corresponding to a title bar representing information on an operation and information on content of the diagnostic images A1 and B1 is displayed in a lower portion of a screen of the image display apparatus 12.

As illustrated in FIG. 1, the image output apparatus 11 and the image display apparatus 12 are connected to each other through a first signal transmission path 13 and a second signal transmission path 14. The first signal transmission path 13 is used to transmit data including medical image data. The second signal transmission path 14 is used to transmit background image region information representing a position of a region which does not include a diagnostic image (hereinafter referred to as a “background image region”) and accompanying image region information representing a position of a region including an accompanying image (hereinafter referred to as an “accompanying image region”).

The first signal transmission path 13 is a transmission path of an SDI (Serial Digital Interface), an HDMI (High-Definition Multimedia Interface) (registered trademark), a DisplayPort, and the like. The second signal transmission path 14 is a transmission path of a USB (Universal Serial Bus), a LAN (Local Area Network), and the like. The first signal transmission path 13 and the second signal transmission path 14 may be wired transmission paths or wireless transmission paths. Furthermore, the first signal transmission path 13 and the second signal transmission path 14 may be a single transmission path instead of individual transmission paths.

The image display apparatus 12 discriminates a background image region and an accompanying image region in a displayed image in accordance with image region information supplied from the image output apparatus 11 through the second signal transmission path 14. The image display apparatus 12 prevents generation of black floating in the background image by performing the local dimming process so as to reduce light emission brightness (luminance) of the backlight in the background image region in accordance with a result of the discrimination of the background image region and performs control so that a doctor who is a user of the image display system 1 may concentrate on analysis of a diagnostic image.

Furthermore, the image display apparatus 12 corrects a brightness value of an accompanying image included in the background image region in accordance with a result of the discrimination of the background image region and the accompanying image region. By this, even when the accompanying image overlaps with the background image region in which the light emission brightness of the backlight is reduced by the local dimming process, visibility of the accompanying image may be maintained.

Hereinafter, configurations and operations of the image output apparatus 11 and the image display apparatus 12 will be described in detail.

### Configurations of Image Output Apparatus 11 and Image Display Apparatus 12

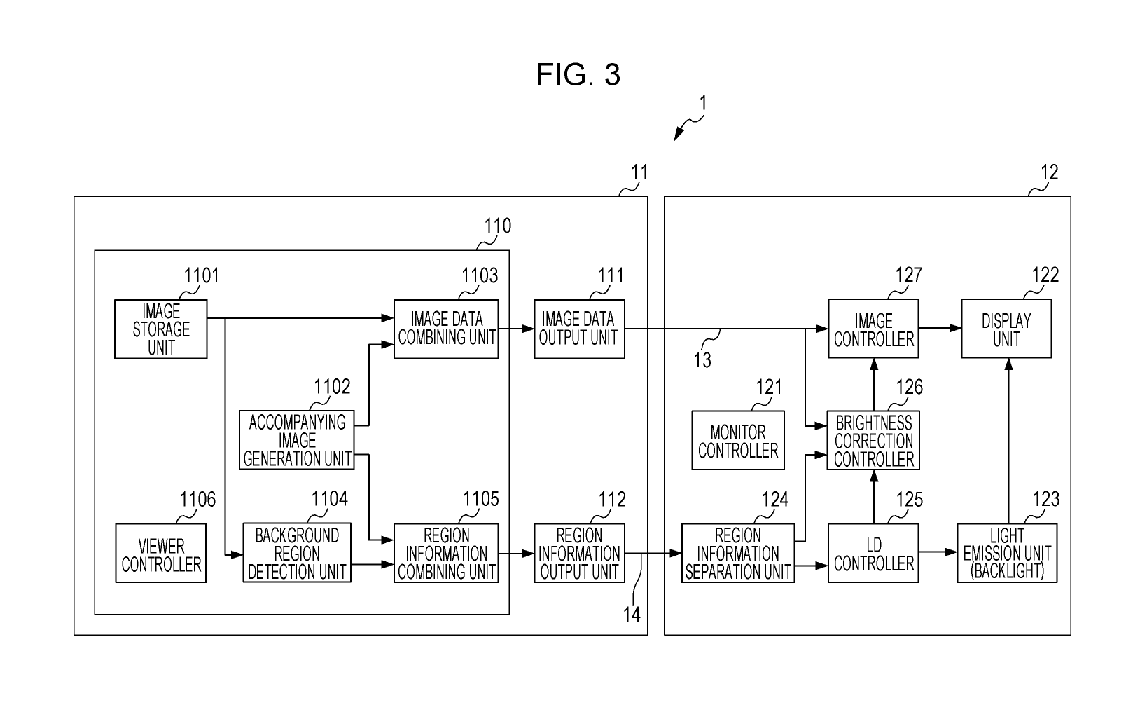

FIG. 3 is a diagram illustrating configurations of the image output apparatus 11 and the image display apparatus 12.

The image output apparatus 11 includes a viewer system 110, an image data output unit 111, and a region information output unit 112. The viewer system 110 converts data of a medical image selected by the user into image data to be viewed and outputs the image data to the image display apparatus 12 through the image data output unit 111. Furthermore, the viewer system 110 outputs image region information through the region information output unit 112 to the image display apparatus 12 which corrects a brightness value of an accompanying image using the image region information. The image data output unit 111 is an HDMI transceiver, for example, and the region information output unit 112 is a USB controller, for example.

The viewer system 110 includes an image storage unit 1101, an accompanying image generation unit 1102, an image data combining unit 1103, a background region detection unit 1104, a region information combining unit 1105, and a viewer controller 1106.

The image storage unit 1101 is a storage medium, such as an HDD (Hard Disk Drive) or an SSD (Solid State Drive), which stores image data generated by an image pickup apparatus, such as medial image data including a medical image captured by a medical device. The image storage unit 1101 stores information representing content of a diagnostic image included in the medical image in a state in which the diagnostic image is associated with the medical image. The image storage unit 1101 stores an image included in a DICOM (Digital Imaging and Communication in Medicine) file serving as medical image data and tag information which are associated with each other.

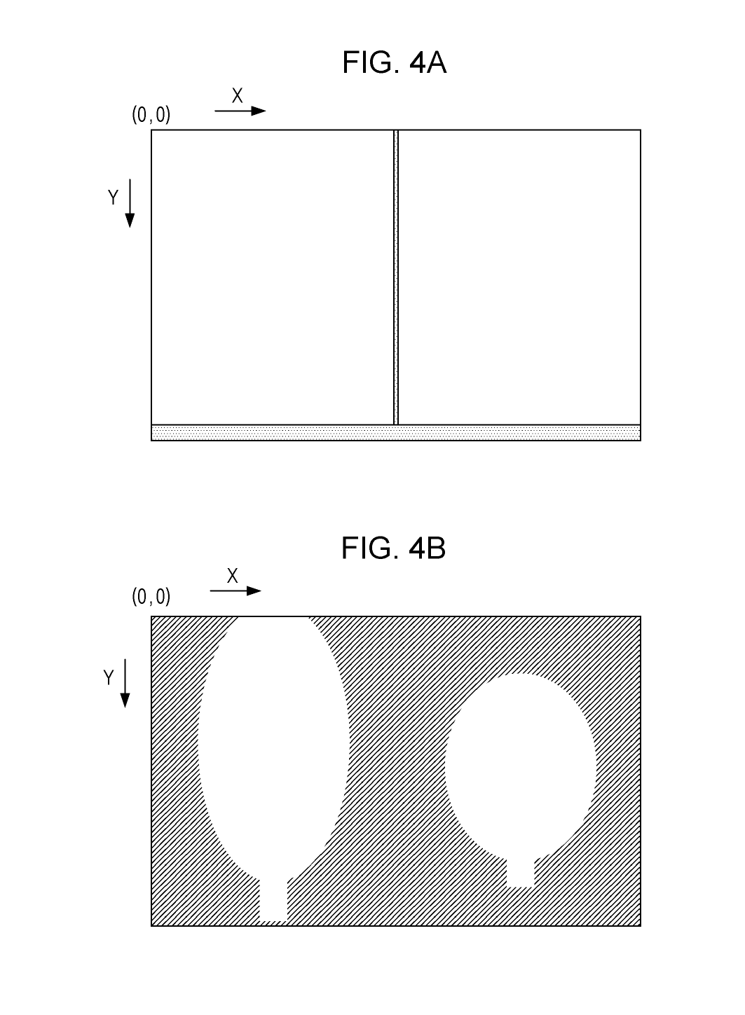

The accompanying image generation unit 1102 generates an accompanying image which is displayed so as to overlap with the medical image selected by the user. The accompanying image generation unit 1102 generates a title bar based on the tag information of the DICOM file stored in the image storage unit 1101 as the accompanying image, for example. FIG. 4A is a diagram schematically illustrating the accompanying image generated by the accompanying image generation unit 1102.

The accompanying image generation unit 1102 outputs the generated accompanying image to the image data combining unit 1103. Furthermore, the accompanying image generation unit 1102 detects an accompanying image region in a display image including the medical image and the accompanying image. Specifically, the accompanying image generation unit 1102 detects a boundary of a region in which the accompanying image overlaps in the display image displayed in the image display apparatus 12 and generates accompanying image region information representing a position of the accompanying image region. The accompanying image generation unit 1102 outputs the generated accompanying image region information to the region information combining unit 1105.

The accompanying image region information includes a plurality of coordinate data represented by (X, Y), that is, positions in the screen of the image display apparatus 12 in a horizontal direction and positions in the screen of the image display apparatus 12 in a vertical direction while an upper left portion of the screen of the image display apparatus 12 is set as an origin as illustrated in FIG. 4A. Specifically, the accompanying image region information includes coordinate data of a plurality of pixels included in a region in which the accompanying image is displayed in the image display apparatus 12.

The image data combining unit 1103 generates image data including a composite image obtained by combining the medical image input from the image storage unit 1101 with the accompanying image generated by the accompanying image generation unit 1102. Specifically, the image data combining unit 1103 multiplies pixel values of the pixels included in the accompanying image by a predetermined weight coefficient and pixel values of pixels included in the medical image are added to the obtained pixels values of the accompanying image so as to generate composite image data, for example. The image data combining unit 1103 generates image data which includes a plurality of frames and which is obtained by adding a predetermined header to the composite image data and outputs the image data to the image data output unit 111.

The background region detection unit 1104 extracts the diagnostic image from the medical image so as to detect a background image region. A hatched portion of FIG. 4B represents a background image obtained by the background region detection unit 1104 after the diagnostic image is extracted from the medical image illustrated in FIG. 2. The background region detection unit 1104 detects the background image region in the display image by searching the medical image for a region in which pixels having brightness values equal to or smaller than a predetermined brightness value are consecutively arranged over a predetermined area or more. The background region detection unit 1104 generates background image region information including coordinate data of a plurality of pixels included in the background image region.

The region information combining unit 1105 combines the accompanying image region information generated by the accompanying image generation unit 1102 with the background image region information generated by the background region detection unit 1104 so as to generate image region information. The image region information includes a plurality of coordinate data which are included in the accompanying image region information and which follow headers representing the accompanying image region information and includes a plurality of coordinate data which are included in the background image region information and which follow headers representing the background image region information. The region information combining unit 1105 outputs the generated image region information to the region information output unit 112.

The viewer controller 1106 includes a CPU (Central Processing Unit), a ROM (Read Only Memory), and a RAM (Random Access Memory) which are connected to the units included in the viewer system 110 through a bus. The viewer controller 1106 integrally controls the viewer system 110 when the CPU executes a program stored in the ROM.

Next, a configuration of the image display apparatus 12 will be described.

The image display apparatus 12 includes a monitor controller 121, a display unit 122, a light emission unit (backlight) 123, a region information separation unit 124, an LD controller 125, a brightness correction controller 126, and an image controller 127.

The monitor controller 121 includes a CPU, a ROM, and a RAM which are connected to the units included in the image display apparatus 12 through a bus. The monitor controller 121 integrally controls the image display apparatus 12 when the CPU executes a program stored in the ROM.

The display unit 122 is a liquid crystal panel which displays a display image based on image data input from the image controller 127.

The light emission unit 123 includes a backlight formed by a light-emitting element, such as a light-emitting diode or a cold-cathode tube, and is disposed at least on a rear side relative to the display unit 122 or in the vicinity of the display unit 122. The light emission unit 123 may change light emission brightness values of the backlight corresponding to a plurality of divided regions (hereinafter referred to as “BL divided regions”) in the display unit 122 under control of the LD controller 125.

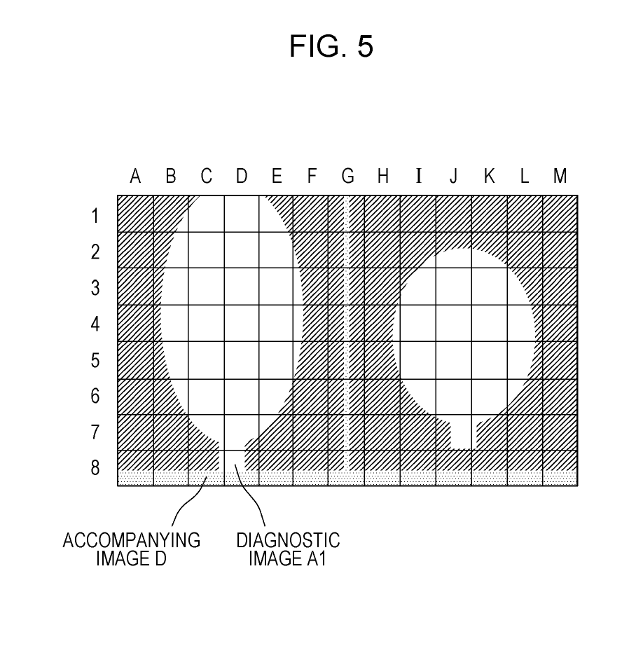

FIG. 5 is a diagram illustrating the BL divided regions. The screen of the display unit 122 is divided in an X direction into 13 regions denoted by addresses A to M and in a Y direction into 8 regions denoted by addresses 1 to 8. The screen of the display unit 122 includes 104 BL divided regions in total obtained by multiplying the number of the regions in the X direction by the number of the regions in the Y direction. Each of the BL divided regions may be identified by a combination of an address in the X direction and an address in the Y direction. For example, an address of a BL divided region corresponding to a region having the address A in the X direction and the address 1 in the Y direction is denoted by A1.

The region information separation unit 124 receives the image region information output from the region information output unit 112 and separates the image region information into the background image region information and the accompanying image region information. The region information separation unit 124 outputs the background image region information to the LD controller 125 and the accompanying image region information to the brightness correction controller 126.

The LD controller 125 determines whether each of the BL divided regions include the diagnostic image in accordance with the background image region information supplied from the region information separation unit 124. When the diagnostic image is not included in a BL divided region, the LD controller 125 performs control so that light emission brightness of the backlight corresponding to the BL divided region becomes a predetermined value which is smaller than light emission brightness of the backlight corresponding to a BL divided region including the diagnostic image. Specifically, the LD controller 125 executes the local dimming process by outputting BL brightness control data used to control the light emission brightness of the backlight to the light emission unit 123. Furthermore, the LD controller 125 outputs light emission brightness reduction region information for identifying a light emission brightness reduction region representing a BL divided region in which the light emission brightness is to be reduced to the brightness correction controller 126.

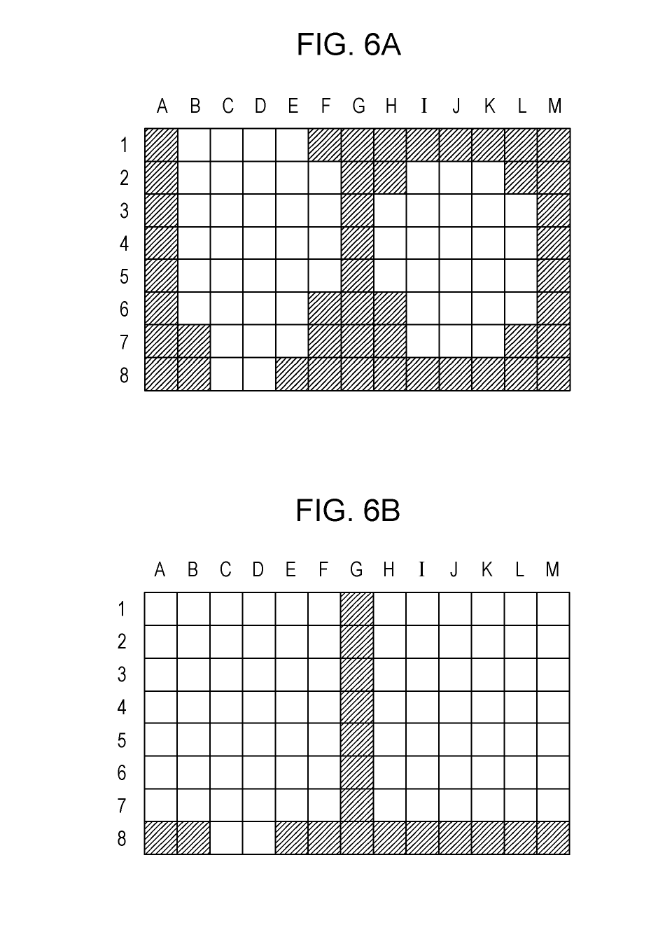

FIG. 6A is a diagram illustrating the light emission brightness reduction region when the medical image illustrated in FIG. 5 is displayed. BL divided regions hatched in FIG. 6A represent BL divided regions which do not include the diagnostic image (for example, BL divided regions denoted by addresses A1 to A8) in the BL divided regions illustrated in FIG. 5. The LD controller 125 generates light emission brightness reduction region information including the addresses of the BL divided regions hatched in FIG. 6A.

The LD controller 125 generates BL brightness control data used to control the brightness values of the backlight corresponding to the individual BL divided regions in accordance with the light emission brightness reduction region information for specifying a light emission brightness reduction region and outputs the BL brightness control data to the light emission unit 123. Specifically, the LD controller 125 controls the light emission unit 123 so that brightness values of the backlight corresponding to a BL brightness reduction region are smaller than those corresponding to the other region by a predetermined light emission brightness reduction amount.

The brightness correction controller 126 corrects a brightness value of the accompanying image included in the background image region in accordance with the background image region information and the accompanying image region information. Specifically, when the accompanying image is included in the light emission brightness reduction region, the brightness correction controller 126 generates correction data by increasing a brightness value of the accompanying image by an amount corresponding to the amount of reduction of the light emission brightness of the backlight. The brightness correction controller 126 does not correct brightness values of images other than the accompanying image included in the background image region.

FIG. 6B is a diagram illustrating BL divided regions in which the brightness of the accompanying image is to be corrected by the brightness correction controller 126. BL divided regions hatched in FIG. 6B represent BL divided regions which include the accompanying image (BL divided regions denoted by addresses A8 and B8, addresses E8 to M8, and addresses G1 to G7) in the brightness reduction region illustrated in FIG. 6A. The brightness correction controller 126 improves visibility of the accompanying image by enhancing the brightness of the accompanying image included in the BL divided regions.

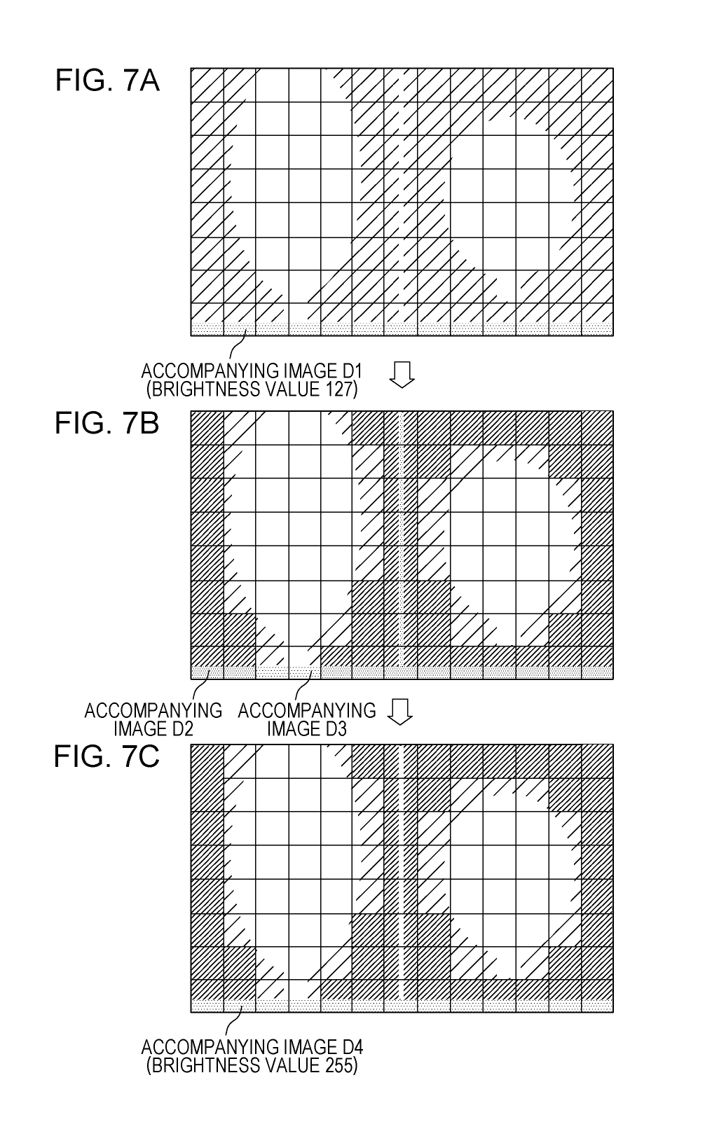

FIGS. 7A to 7C are diagrams illustrating an effect of the correction of the brightness of the accompanying image performed by the brightness correction controller 126. It is assumed here that the maximum value of display brightness of the display unit 122 is 300 [cd/m²], the light emission brightness of the backlight may be changed in a range from 20 percent to 100 percent, and the brightness value of the accompanying image may be changed in a range from 0 to 255. Note that the display brightness represents brightness [cd/m²] observed in a state in which an image is displayed in the display unit 122 and is determined in accordance with the light emission brightness of the backlight and the brightness value of the image. In a case where the light emission brightness of the backlight is 100 percent and the brightness value of the accompanying image is 255, for example, the display brightness is 300 [cd/m²].

In FIG. 7A, a state in which the light emission brightness of the backlight corresponding to the background image region and the light emission brightness of the backlight corresponding to the diagnostic image region are equal to each other, that is, a state in which the local dimming process has not been performed, is illustrated. The display unit 122 displays an accompanying image D1 having a brightness value of 127 in a state in which the light emission brightness of the backlight is maximum (100 percent), and display brightness of the accompanying image D1 is approximately 150 [cd/m²].

In FIG. 7B, a state in which the light emission brightness of the backlight corresponding to the background image region is reduced to 50 percent relative to the maximum value is illustrated. In this state, display brightness of an accompanying image D2 in BL divided regions which do not include the diagnostic image is approximately 75 [cd/m²], that is, the display brightness of the accompanying image D2 is smaller than the display brightness of the accompanying image D1 illustrated in FIG. 7A. The display brightness of the accompanying image D2 in the BL divided regions which do not include the diagnostic image and display brightness of an accompanying image D3 in BL divided regions which include the diagnostic image are different from each other.

In FIG. 7C, a state in which a brightness value of an accompanying image D4 is set to 255 while the light emission brightness of the backlight corresponding to the background image region is reduced to 50 percent relative to the maximum value as with the case of FIG. 7B is illustrated. In this case, even in the state in which the light emission brightness of the backlight is 50 percent of the maximum value, the display brightness is approximately 150 [cd/m²]. As a result, even though the light emission brightness of the backlight corresponding to the background image region is reduced, the display brightness of the accompanying image D4 may be equal to the display brightness of the accompanying image D1 illustrated in FIG. 7A.

Since the brightness correction controller 126 controls the brightness value of the accompanying image as described above, visibility of the accompanying image may be maintained even when the light emission brightness of the backlight is reduced by the LD controller 125. However, when the brightness of the accompanying image before the correction is comparatively high, sufficient display brightness of the accompanying image may not be ensured since an amount of increment of the brightness value of the accompanying image is small relative to an amount of reduction of the light emission brightness of the backlight. In this case, even if the brightness value of the accompanying image is corrected at a maximum, a region having different display brightness is generated in the single accompanying image as illustrated in FIG. 7B.

Therefore, when the brightness value of the accompanying image may not be increased by an amount for complementing an amount of the reduction of the light emission brightness of the backlight, the brightness correction controller 126 generates correction data used to correct brightness of the accompanying image included in regions other than the background image region. Specifically, when the accompanying image is consecutively included in the background image region in which the light emission brightness of the backlight is reduced and the region in which the light emission brightness of the backlight is not reduced other than the background image region, the brightness correction controller 126 generates correction data by reducing the brightness value of the accompanying image in the region other than the background image region by an amount corresponding to the amount of the reduction of the light emission brightness of the backlight. By this, the display brightness of the accompanying image region in the background image region and the display brightness of the accompanying image region in the region other than the background image region become equal to each other.

It is assumed that the brightness value of the accompanying image is 127, the light emission brightness of the backlight corresponding to the brightness reduction region which does not include the diagnostic image is 20 percent of the maximum value, and the display brightness is approximately 30 [cd/m²]. In this case, even if the brightness value of the accompanying image is set to 255, that is, the maximum value, the display brightness only reaches approximately 60 [cd/m²] which is far smaller than the display brightness 150 [cd/m²] of the accompanying image in the BL divided regions including the diagnostic image. Therefore, the brightness correction controller 126 may set the brightness value of the accompanying image to 76 (brightness value of 127×60/150) in the BL divided regions including the diagnostic image so that the display brightness of the accompanying image in the BL divided regions including the diagnostic image of approximately 60 [cd/m²] is obtained.

The image controller 127 receives the image data transmitted by the image output apparatus 11 and generates image data by changing setting values of image parameters relating to brightness, gamma, and a color tone in accordance with a user's operation. The image controller 127 generates image data in which the brightness of the accompanying image included therein is corrected in accordance with the correction data generated by the brightness correction controller 126 and outputs the corrected image data to the display unit 122.

### Flowcharts of Operations of Image Output Apparatus 11 and Image Display Apparatus 12

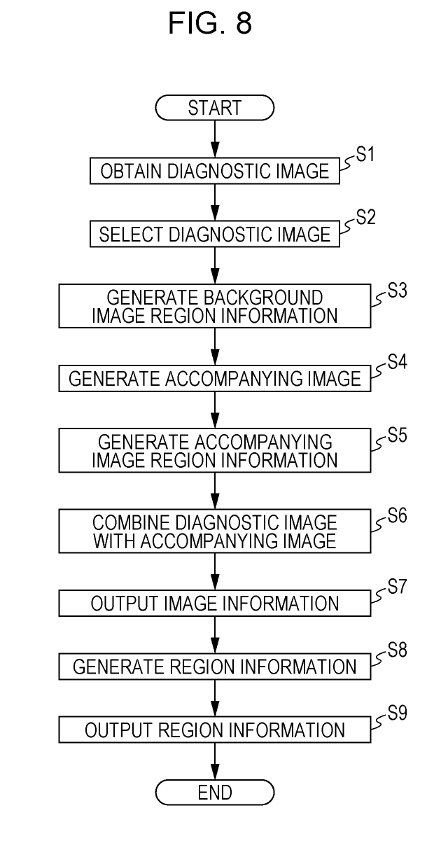

FIG. 8 is a flowchart illustrating a procedure of an operation of the image output apparatus 11 under control of a viewer controller 1106. First, the image output apparatus 11 obtains medical images through an external interface (not illustrated), such as a LAN interface or a USB interface, and stores the medical images in the image storage unit 1101 (step S1).

Next, the image output apparatus 11 receives a selection of a medical image to be displayed in the image display apparatus 12 from among the plurality of medical images stored in the image storage unit 1101 in accordance with a user's operation (step S2). Subsequently, the background region detection unit 1104 detects a background region in the selected medical image and generates background image region information representing the detected background region (step S3).

Thereafter, the accompanying image generation unit 1102 generates an accompanying image in accordance with character information included in a data file of the medical image selected in step S2, the number of selected medical images, and the like (step S4). The accompanying image generation unit 1102 generates accompanying image region information (step S5). The image output apparatus 11 may execute the process in step S4 and the process in step S5 before the process in step S3.

Subsequently, the image data combining unit 1103 generates a composite image by overlapping the medical image and the accompanying image with each other (step S6). The image data output unit 111 outputs image data including the composite image generated by the image data combining unit 1103 (step S7).

The region information combining unit 1105 combines the background image region information with the accompanying image region information so as to generate region information (step S8). The region information output unit 112 outputs the region information generated by the region information combining unit 1105 (step S9). The image output apparatus 11 may execute the procedure in step S8 and step S9 at an arbitrary timing after the procedure in step S3 to step S5 is executed.

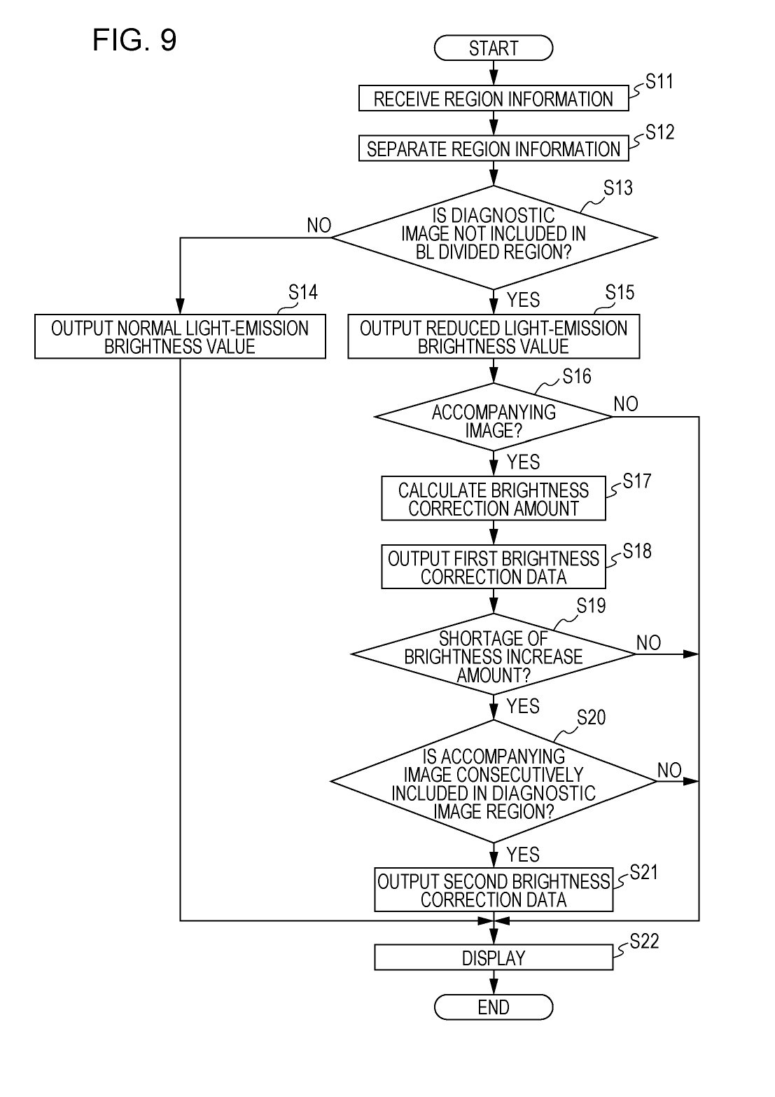

FIG. 9 is a flowchart illustrating an operation procedure of the image display apparatus 12 under control of the monitor controller 121. When the image display apparatus 12 receives the region information (step S11), the region information separation unit 124 separates the region information into the background image region information and the accompanying image region information (step S12). The region information separation unit 124 outputs the background image region information to the LD controller 125 and the brightness correction controller 126 and the accompanying image region information to the brightness correction controller 126.

Subsequently, the LD controller 125 determines whether an entire BL divided region is the background image for each BL divided region, that is, whether the diagnostic image is included in an BL divided region for each BL divided region, in accordance with the background image region information supplied from the region information separation unit 124 (step S13). When determining that the diagnostic image is included in a BL divided region which is a target of the determination, that is, when the determination is negative in step S13, the LD controller 125 outputs a normal light emission brightness value to the light emission unit 123 (step S14). In this case, the light emission unit 123 turns on the backlight in normal light emission brightness.

When determining that the diagnostic image is not included in the BL divided region which is the target of the determination, that is, when the determination is affirmative in step S13, the LD controller 125 outputs a predetermined reduced light emission brightness value to the light emission unit 123 so that the light emission brightness of the backlight corresponding to the BL divided region is reduced (step S15). Subsequently, the monitor controller 121 controls the brightness correction controller 126 so that visibility of the accompanying image included in the BL divided region in which the light emission brightness of the backlight is reduced is improved so as to correct the brightness of the accompanying image (step S16 to step S21).

First, the brightness correction controller 126 determines whether the accompanying image is included in the BL divided region in which the light emission brightness of the backlight is reduced (step S16). When the accompanying image is not included in the BL divided region, that is, when the determination is negative in step S16, only the background image is included in the BL divided region, and accordingly, the brightness correction controller 126 does not output a correction value of brightness to the image controller 127.

When determining that the accompanying image is included in the BL divided region in step S16, that is, when the determination is affirmative in step S16, the brightness correction controller 126 calculates a brightness correction amount representing an amount of increase of the brightness value of the accompanying image which is required for increasing display brightness of a region where the accompanying image is to be displayed to display brightness obtained before the light emission brightness of the backlight is reduced (step S17). The brightness correction controller 126 generates first brightness correction data including the brightness value for increasing the brightness of the accompanying image in accordance with the brightness correction amount and outputs the first brightness correction data to the image controller 127 (step S18).

The brightness correction controller 126 determines whether shortage of the brightness increase amount for the first brightness correction data has occurred (step S19). When the first brightness correction data for increasing the brightness value by the amount corresponding to the brightness correction amount calculated in step S17 is generated in step S18, that is, when the determination is negative in step S19, the brightness correction controller 126 terminates the process without further correcting the brightness of the accompanying image.

When the first brightness correction data for increasing the brightness value by the amount corresponding to the brightness correction amount calculated in step S17 is not generated in step S18, that is, when the determination is affirmative in step S19, the brightness correction controller 126 determines whether the accompanying image is consecutively included in a BL divided region which does not include the diagnostic image and a BL divided region which includes the diagnostic image (step S20). When determining that the accompanying image is not included in the BL divided region including the diagnostic image, that is, when the determination is negative in step S20, the brightness correction controller 126 terminates the process without further correcting the brightness of the accompanying image.

When determining that the accompanying image is also included in the BL divided region including the diagnostic image, that is, when the determination is affirmative in step S20, the brightness correction controller 126 outputs second brightness correction data for correcting the brightness of the accompanying image included in the BL divided region including the diagnostic image (step S21). Specifically, the brightness correction controller 126 first obtains a difference between the brightness correction amount calculated in step S17 and the brightness increase amount of the accompanying image according to the first brightness correction data. Thereafter, the brightness correction controller 126 generates and outputs the second brightness correction data including a brightness value for reducing the brightness of the accompanying image included in the BL divided region including the diagnostic image by an amount corresponding to the difference. By this, the display unit 122 may not generate a difference between the display brightness of the accompanying image in the BL divided regions including the background image and the display brightness of the accompanying image in the BL divided regions including the diagnostic image.

Subsequently, the image controller 127 generates image data in which the brightness value of the accompanying image included in the individual BL divided regions are corrected in accordance with a result of the process described above and causes the display unit 122 to display an image (step S22).

### Effect of First Embodiment

As described above, the image display apparatus 12 of the first embodiment performs the local dimming process for controlling the light emission brightness of the backlight in accordance with the background image region information and the accompanying image region information supplied from the image output apparatus 11, and in addition, controls the brightness value of the accompanying image. By this, the image display apparatus 12 may reduce the light emission brightness of the backlight corresponding to the background image region so that the diagnostic image is easily viewed and maintain excellent visibility of the accompanying image even when the accompanying image is included in the region in which the light emission brightness of the backlight is reduced.

Furthermore, when the single accompanying image is consecutively included in the BL divided region which does not include the diagnostic image and the BL divided region which includes the diagnostic image and when the brightness value of the accompanying image in the BL divided region which does not include the diagnostic image may not be sufficiently increased, the image display apparatus 12 reduces the brightness value of the accompanying image included in the BL divided region which includes the diagnostic image. In this way, the display brightness in a region in which the single accompanying image is displayed is prevented from being varied.

### Second Embodiment

### Configurations of Image Output Apparatus 21 and Image Display Apparatus 22

In the image display system 1 according to the first embodiment, the image display apparatus 12 specifies the BL divided regions in which the brightness of the accompanying image is to be corrected in accordance with the background image region information and the accompanying image region information for each pixel supplied from the image output apparatus 11 and corrects the brightness of the accompanying image included in the specified BL divided regions. However, an image display system 2 according to a second embodiment is different from the image display system 1 according to the first embodiment in that an image display apparatus 22 transmits information for specifying a BL divided region to an image output apparatus 21 and the image output apparatus 21 transmits background image region information generated for each BL divided region and accompanying image region information generated for each BL divided region to the image display apparatus 22. Furthermore, the image display system 2 according to the second embodiment is different from the image display system 1 according to the first embodiment also in that the image output apparatus 21 corrects an accompanying image in accordance with a result of correction of a brightness value of the accompanying image performed by the image display apparatus 22.

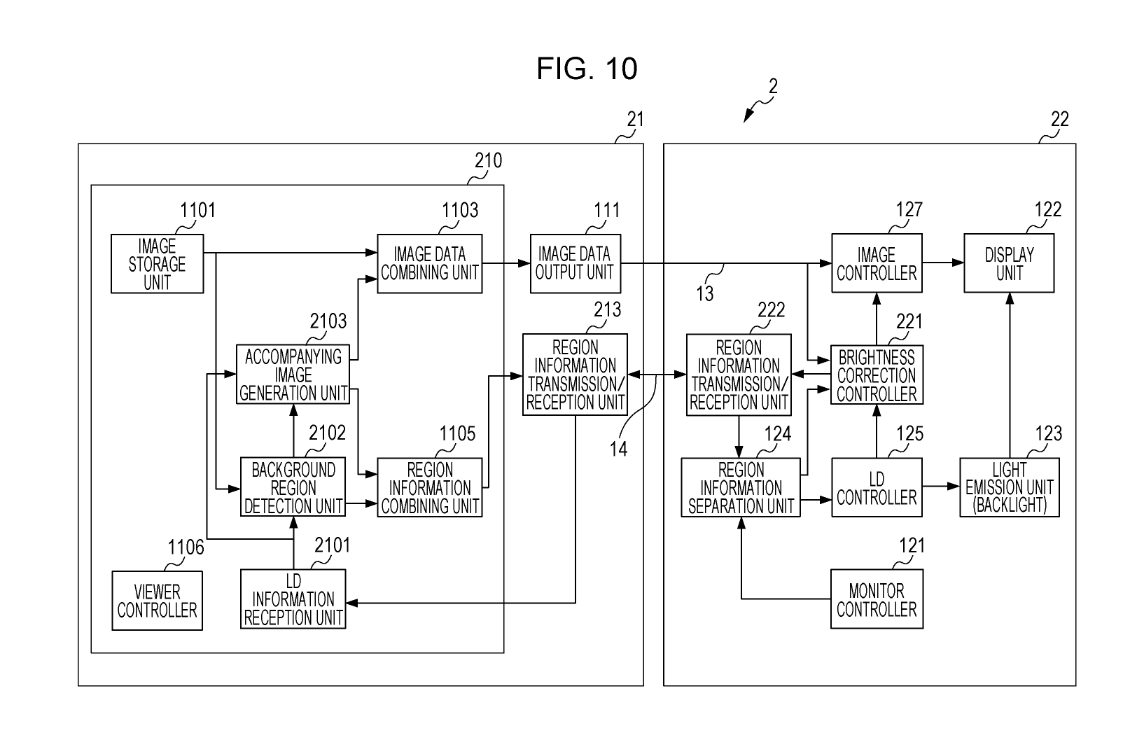

FIG. 10 is a diagram illustrating configurations of the image output apparatus 21 and the image display apparatus 22 according to the second embodiment. Blocks having functions the same as those of the image output apparatus 11 and the image display apparatus 12 according to the first embodiment illustrated in FIG. 3 are denoted by reference numerals the same as those in FIG. 3. Referring to FIG. 10, points different from the first embodiment will be mainly described hereinafter.

The image output apparatus 21 includes a viewer system 210 instead of the viewer system 110 illustrated in FIG. 3 and includes a region information transmission/reception unit 213 instead of the region information output unit 112. The viewer system 210 includes an accompanying image generation unit 2103 and a background region detection unit 2102 instead of the accompanying image generation unit 1102 and the background region detection unit 1104 included in the viewer system 110, respectively. The viewer system 210 further includes an LD information reception unit 2101.

The image display apparatus 22 includes a brightness correction controller 221 instead of the brightness correction controller 126. The image display apparatus 22 further includes a region information transmission/reception unit 222.

The region information transmission/reception unit 222 transmits BL divided region information including coordinate data used to specify individual BL divided regions, light emission brightness reduction amount information representing an amount of reduction of light emission brightness of a backlight, and accompanying image brightness information representing a brightness value of a corrected accompanying image to the region information transmission/reception unit 213.

The LD information reception unit 2101 receives the BL divided region information, the light emission brightness reduction amount information, and the accompanying image brightness information through the region information transmission/reception unit 213. The LD information reception unit 2101 outputs the received BL divided region information to the background region detection unit 2102 and the accompanying image generation unit 2103 and outputs the light emission brightness reduction amount information and the accompanying image brightness information to the accompanying image generation unit 2103.

The background region detection unit 2102 separates a medical image into a diagnostic image and a background image, as with the background region detection unit 1104, and generates background image region information. The background region detection unit 2102 generates divided background image region information representing whether each BL divided region is a background image region in accordance with the BL divided region information supplied from the LD information reception unit 2101. The background region detection unit 2102 outputs the divided background image region information associated with BL divided regions to a region information combining unit 1105. The divided background image region information includes addresses of BL divided regions hatched in FIG. 6A.

The accompanying image generation unit 2103 generates, as with the accompanying image generation unit 1102, an accompanying image under control of a viewer controller 1106. Furthermore, the accompanying image generation unit 2103 generates divided accompanying image region information representing as to whether each BL divided region includes the accompanying image. The accompanying image generation unit 2103 outputs the divided accompanying image region information associated with BL divided regions to the region information combining unit 1105. The divided accompanying image region information includes addresses of BL divided regions hatched in FIG. 6B.

Furthermore, the accompanying image generation unit 2103 corrects image data of the accompanying image included in a light emission brightness reduction region in which a light emission brightness of the backlight is reduced by the image display apparatus 22 in accordance with the divided background image region information, the light emission brightness reduction amount information, and the accompanying image brightness information. When it is determined that display brightness in a region in which the accompanying image having a corrected brightness value is to be displayed in the image display apparatus 22 is smaller than a predetermined threshold value, the accompanying image generation unit 2103 corrects the accompanying image. Specifically, the accompanying image generation unit 2103 performs image correction for changing at least a type, a thickness of a line, or a color of characters included in the accompanying image. Furthermore, when the single accompanying image is consecutively included in the light emission brightness reduction region and a region other than the light emission brightness reduction region, the accompanying image generation unit 2103 performs correction so that a brightness value of the accompanying image included in the region other than the brightness reduction region is reduced, and in addition, performs the image correction described above. The accompanying image generation unit 2103 outputs the corrected accompanying image to an image data combining unit 1103.

The region information combining unit 1105 combines the divided background image region information with the divided accompanying image region information so as to generate divided image region information associated with BL divided regions. The region information transmission/reception unit 213 transmits the divided image region information to the region information transmission/reception unit 222.

In the image display apparatus 22, when the region information transmission/reception unit 222 receives the divided image region information, a region information separation unit 124 separates the divided image region information into the divided background image region information and the divided accompanying image region information. Unlike the first embodiment, an LD controller 125 may perform the local dimming process for each BL divided region in accordance with the divided background image region information without performing a determination as to whether a diagnostic image is included in a BL divided region for each BL divided region.

### Operation Flowchart

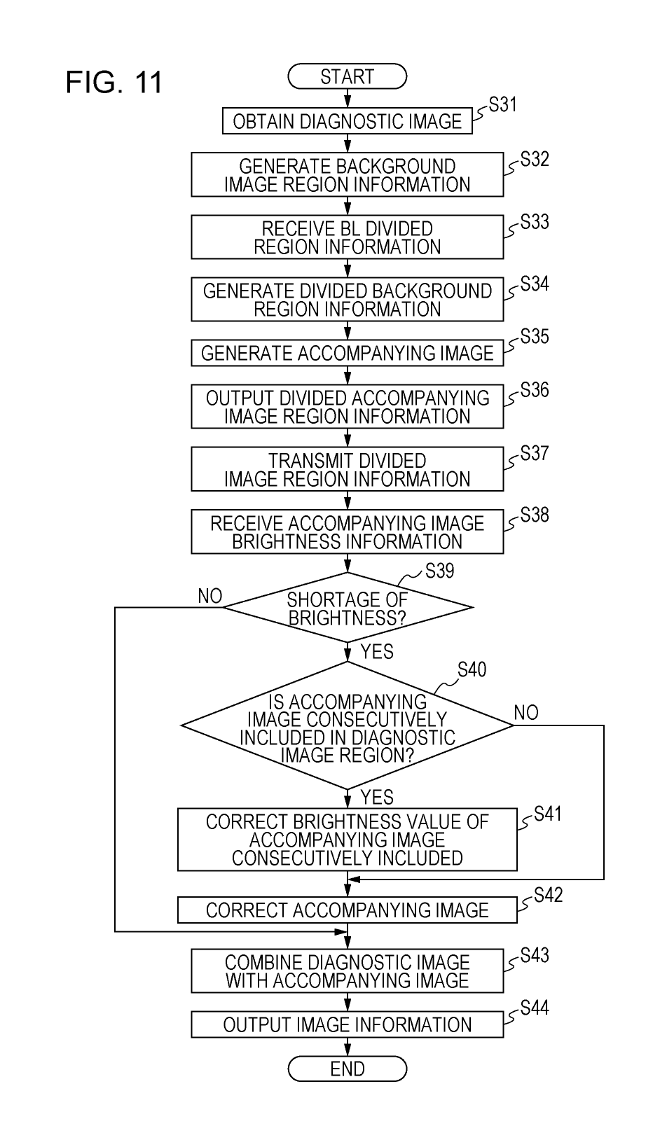

FIG. 11 is a flowchart illustrating a procedure of an operation of the image output apparatus 21 under control of the viewer controller 1106.

First, the image output apparatus 21 obtains medical images and stores the medical images in an image storage unit 1101 (step S31). Subsequently, the background region detection unit 2102 detects a background region in a medical image selected by a user and generates background image region information representing the detected background region (step S32).

The LD information reception unit 2101 receives the BL divided region information through the region information transmission/reception unit 213 and outputs BL divided region information to the background region detection unit 2102 (step S33). The background region detection unit 2102 generates divided background image region information in accordance with the background image region information generated in step S32 and the BL divided region information input in step S33 and outputs the divided background image region information to the accompanying image generation unit 2103 (step S34).

The accompanying image generation unit 2103 generates an accompanying image in accordance with data included in the medical image selected by the user (step S35). Furthermore, the accompanying image generation unit 2103 generates divided accompanying image region information in accordance with accompanying image region information and the BL divided region information (step S36). Subsequently, the region information combining unit 1105 generates divided image region information by combining the divided background image region information with the divided accompanying image region information and transmits the divided image region information to the image display apparatus 22 through the region information transmission/reception unit 213 (step S37).

The LD information reception unit 2101 receives light emission brightness reduction amount information and accompanying image brightness information from the image display apparatus 22 and outputs the light emission brightness reduction amount information and the accompanying image brightness information to the accompanying image generation unit 2103 (step S38). The accompanying image generation unit 2103 determines whether shortage of display brightness of the accompanying image has occurred as a result of the local dimming process in accordance with the input light emission brightness reduction amount information and the input accompanying image brightness information (step S39). Note that, in a case where the image display apparatus 22 transmits the brightness reduction amount information and the accompanying image brightness information when the shortage of the display brightness has occurred, the accompanying image generation unit 2103 may skip the process in step S39.

When determining that the shortage of the display brightness of the accompanying image has occurred in step S39, the accompanying image generation unit 2103 determines whether the accompanying image is consecutively included in a BL divided region which does not include a diagnostic image and a BL divided region which includes the diagnostic image (step S40). When determining that the accompanying image is consecutively included in the BL divided region which does not include the diagnostic image and the BL divided region which includes the diagnostic image, that is, when the determination is affirmative in step S40, the accompanying image generation unit 2103 corrects the brightness value of the accompanying image (step S41). Specifically, the accompanying image generation unit 2103 corrects the brightness value of the accompanying image so that the brightness of the accompanying image included in BL divided regions which are not included in the background image region is reduced so that display brightness of the accompanying image in BL divided regions which are included in the background image region and display brightness of the accompanying image included in the BL divided regions which are not included in the background image region are not different from each other. When the determination is negative in step S40, the accompanying image generation unit 2103 proceeds to step S42 without executing the process in step S41.

Subsequently, the accompanying image generation unit 2103 detects an amount of shortage of the brightness of the accompanying image in accordance with the brightness reduction amount information and the accompanying image brightness information and performs image correction for changing at least one of a type, a thickness of a line, and a color of characters included in the accompanying image in accordance with the amount of shortage of the brightness (step S42). By this, the image output apparatus 21 may improve visibility degraded due to the shortage of the brightness of the accompanying image. Note that the accompanying image generation unit 2103 may execute the process in step S42 before the process in step S40.

The accompanying image generation unit 2103 outputs accompanying image data which has been subjected to the brightness correction and the image correction to the image data combining unit 1103. The image data combining unit 1103 combines medical image data with the corrected accompanying image data (step S43). The image data output unit 111 outputs image data including the composite image data to the image display apparatus 22 (step S44).

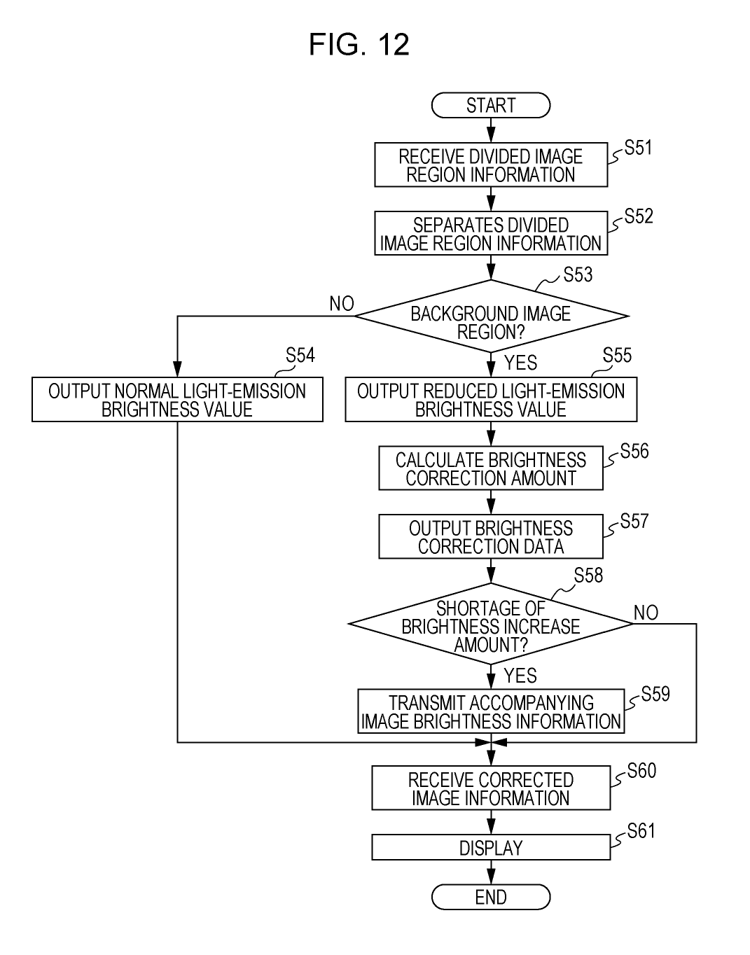

FIG. 12 is a flowchart illustrating an operation procedure of the image display apparatus 22 under control of a monitor controller 121.

First, when receiving the divided image region information (step S51), the image display apparatus 22 separates the divided image region information into the divided background image region information and the divided accompanying image region information (step S52). The region information separation unit 124 outputs the divided background image region information to the LD controller 125 and the brightness correction controller 221 and the divided accompanying image region information to the brightness correction controller 221.

Subsequently, the LD controller 125 determines whether an entire BL divided region is a background image for each BL divided region in accordance with the divided background image region information (step S53). When determining that the diagnostic image is included in a BL divided region which is a target of the determination, that is, when the determination is negative in step S53, the LD controller 125 outputs a normal light emission brightness value to the light emission unit 123 (step S54).

When determining that the diagnostic image is not included in the BL divided region which is the target of the determination, that is, when the determination is affirmative in step S53, the LD controller 125 outputs a reduced light emission brightness value to the light emission unit 123 so that the light emission brightness of the backlight corresponding to the BL divided region is reduced to predetermined brightness (step S55).

Subsequently, the brightness correction controller 221 calculates an amount of correction of the brightness value of the accompanying image corresponding to the BL divided regions in the background image region which includes the accompanying image in accordance with the divided background image region information and the divided accompanying image region information supplied from the region information separation unit 124 (step S56). The brightness correction controller 221 generates correction data including a brightness value used to increase the brightness of the accompanying image so that display brightness of a region in which the accompanying image is to be displayed becomes equal to display brightness obtained before the light emission brightness of the backlight is reduced and outputs the correction data to the image controller 127 (step S57).

The brightness correction controller 221 determines whether shortage of the brightness increase amount for the accompanying image has occurred in accordance with the brightness correction data (step S58). Specifically, the brightness correction controller 221 determines whether shortage of the brightness increase amount occurs even when the accompanying image is corrected using the brightness correction data generated in step S57, and therefore, the light emission brightness of the backlight may not become equal to the display brightness obtained before the light emission brightness of the backlight is reduced. When determining that the shortage of the brightness correction amount has occurred, the brightness correction controller 221 transmits the accompanying image brightness information including information on a brightness shortage amount to the image output apparatus 21 through the region information transmission/reception unit 222 (step S59). The brightness correction controller 221 transmits the accompanying image brightness information associated with addresses of BL divided regions in which the brightness of the accompanying image is to be corrected to the image output apparatus 21, for example.

After the image output apparatus 21 executes the process from step S39 to step S44 in FIG. 11, the image display apparatus 22 receives image data including the accompanying image corrected by the image output apparatus (step S60). The image controller 127 displays the medical image including the accompanying image in the display unit 122 after performing a predetermined image process on an image included in the received image data (step S61).

### Effect of Second Embodiment

As described above, the image display system 2 of the second embodiment may correct the accompanying image also using the image output apparatus 21. Accordingly, even in a case where visibility of the accompanying image is not sufficiently ensured only by correcting the brightness of the accompanying image by the image display apparatus 22, a type, a thickness of a line, a color, and the like of characters of the accompanying image may be changed as correction by the image output apparatus 21. As a result, the visibility of the accompanying image included in the region in which the light emission brightness of the backlight is reduced may be further improved.

Furthermore, the image output apparatus 21 obtains a BL divided region and generates divided accompanying image region information and divided background image region information associated with the BL divided region. Accordingly, since the image output apparatus 21 may transmit region information to the image display apparatus 22 for each BL divided region, an amount of data to be transmitted through the second signal transmission path 14 may be reduced, and in addition, a processing load of the image display apparatus 22 may be reduced.

### Third Embodiment

In the first and second embodiments, the image display system 1 and the image display system 2 transmit and receive the image data and the region information through different transmission paths. On the other hand, an image display system 3 according to a third embodiment transmits and receives region information through a transmission path used for transmitting image data in a blanking period in which the image data is not transmitted.

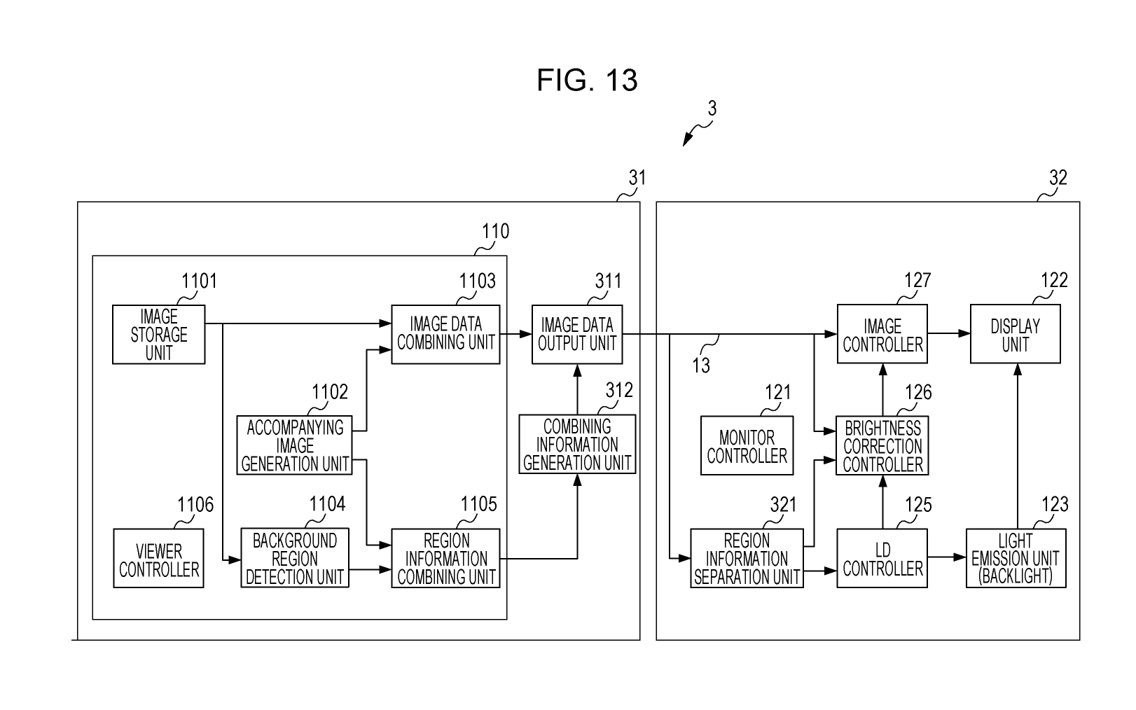

FIG. 13 is a diagram illustrating configurations of an image output apparatus 31 and an image display apparatus 32 according to the third embodiment. Blocks having functions the same as those of the image output apparatus 11 and the image display apparatus 12 according to the first embodiment illustrated in FIG. 3 are denoted by reference numerals the same as those in FIG. 3. Referring to FIG. 13, points different from the first embodiment will be described hereinafter.

The image output apparatus 31 includes an image data output unit 311 instead of the image data output unit 111 included in the image output apparatus 11 illustrated in FIG. 3 and includes a combining information generation unit 312 instead of the region information output unit 112. The combining information generation unit 312 generates combining information used to combine image region information with image data in the blanking period of the image data in accordance with image region information including background image region information and accompanying image region information. Specifically, the combining information generation unit 312 generates the combining information by buffer region information supplied from a region information combining unit 1105 and outputs the combining information to the image data output unit 311 in the blanking period of the image data. The image data output unit 311 combines the image data supplied from an image data combining unit 1103 with the combining information supplied from the combining information generation unit 312 and outputs the combined image data to the image display apparatus 32.

The image display apparatus 32 includes a region information separation unit 321 instead of the region information separation unit 124 included in image display apparatus 12 illustrated in FIG. 3. The region information separation unit 321 extracts the combining information transmitted in the blanking period of the image data supplied from the image data output unit 311 and obtains the image region information included in the combining information. The region information separation unit 321 separates, as with the region information separation unit 124, the image region information into background image region information and accompanying image region information.

### Effect of Third Embodiment

As described above, the image display system 3 of the third embodiment transmits and receives the region information in the blanking period of the image data. Accordingly, the number of transmission paths between the image output apparatus 31 and the image display apparatus 32 may be reduced.

### First Modification

In the first and second embodiments, the image display apparatus 12 and the image display apparatus 22 reduce the brightness of the backlight corresponding to the background image region to the predetermined value, and thereafter, perform control so that the brightness values of the accompanying image included in the BL divided regions which are not included in the background image region are reduced when shortage of the display brightness occurs even when the brightness value of the accompanying image is corrected. However, the image display apparatus 12 and the image display apparatus 22 may reduce the brightness of the backlight in a range in which the display brightness of the accompanying image before the brightness of the backlight is reduced is maintained by correcting the brightness value of the accompanying image while the light emission brightness of the backlight corresponding to the background image region is gradually reduced.

### Second Modification

In the third embodiment, the background image region information and the accompanying image region information are embedded in the blanking period of the image data. However, the same effect is obtained even in a case where one-bit data serving as the background image region information and one-bit data serving as the accompanying image region information are included in pieces of image data corresponding to individual pixels included instead of the case of the blanking period.

The embodiments of the present inventions have been described hereinabove. The technical scope of the present inventions is not limited to the foregoing embodiments and various modifications and alterations may be made within the scope of the inventions.

For example, although each of the image output apparatus and the image display apparatus includes a CPU in the foregoing embodiments, a single CPU may control the units of the image output apparatus and the image display apparatus. Furthermore, although the image output apparatus generates the accompanying image in the foregoing embodiments, the image output apparatus may obtain the accompanying image from an external apparatus.

Moreover, although the diagnostic image is included in the medical image obtained from the medical apparatus in the foregoing embodiments, the diagnostic image is not limited to medical-associated images and may be a predetermined object image. Examples of the predetermined object image may include an image which is not associated with medical care and which is generated by being captured by another image pickup apparatus, such as a measurement apparatus or a monitoring apparatus. For example, the predetermined object image may be an image of a person or a product captured in front of a set in a studio, may be an image of a person while setting sky or sea in an outdoor as a background, or may be an image of a product, such as a vehicle, captured while setting a field of grass as a background.

### Other Embodiments

Embodiments of the present inventions can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present inventions have been described with reference to exemplary embodiments, it is to be understood that the inventions are not limited to the disclosed exemplary embodiments. The scope of the following claims is to be accorded the broadest interpretation so as to encompass all such modifications and equivalent structures and functions.

This application claims the benefit of Japanese Patent Application No. 2014-098453, filed May 12, 2014, which is hereby incorporated by reference herein in its entirety.

What is claimed is:

1. An image display system which displays a display image including an object image, the image display system comprising:
a first detection unit configured to detect a background image region, which does not include the object image, in the display image;
a second detection unit configured to detect an accompanying image region including an accompanying image displayed in association with the display image;
a display unit configured to display the display image;
a light emission unit configured to be capable of changing light emission brightness corresponding to a plurality of divided regions in the display unit;
a controller configured to control the light emission brightness in the plurality of divided regions in accordance with the background image region; and
a brightness correction unit configured to correct a brightness value of at least a first portion of the accompanying image included in the background image region in accordance with at least the accompanying image region.

2. The image display system according to claim 1, wherein
the brightness correction unit increases the brightness value of at least the first portion of the accompanying image included in the background image region.

3. The image display system according to claim 1, wherein
the brightness correction unit corrects the brightness value of the accompanying image so that display brightness in a first region in which at least the first portion of the accompanying image in the background image region is displayed is equal to display brightness in a second region in which at least a second portion of the accompanying image is displayed, the second region being a region other than or different from the background image region.

4. The image display system according to claim 3, wherein
the brightness correction unit increases the brightness value of at least the first portion of the accompanying image included in the background image region so that the brightness value of at least the first portion of the accompanying image included in the background image region is larger than a brightness value of at least the second portion of the accompanying image included in the second region other than or different from the background image region.

5. The image display system according to claim 1, wherein
the brightness correction unit increases the brightness value of at least the first portion of the accompanying image included in the background image region by an amount corresponding to an amount of reduction of the light emission brightness of the light emission unit.

6. The image display system according to claim 1, wherein
the brightness correction unit reduces a brightness value of at least a second portion of the accompanying image included in a region other than the background image region when the brightness value of at least the first portion of the accompanying image included in the background image region is not allowed to be increased by an amount corresponding to an amount of reduction of the light emission brightness of the light emission unit.

7. The image display system according to claim 1, wherein
the brightness correction unit changes at least one of a type, a thickness of lines, and a color of characters of at least the first portion of the accompanying image when the brightness value of at least the first portion of the accompanying image included in the background image region is not allowed to be increased by an amount corresponding to an amount of reduction of the light emission brightness of the light emission unit.

8. The image display system according to claim 1, wherein
the brightness correction unit does not correct brightness values of images other than the accompanying image, or at least the first portion of the accompanying image, included in the background image region.

9. The image display system according to claim 1, wherein
the first detection unit detects a number of the divided regions which do not include the object image as and/or in the background image region in accordance with divided-region information representing positions of the divided regions which are a unit in which the light emission brightness of the light emission unit is reduced, and
the second detection unit detects a number of the divided regions which include the accompanying image as and/or in the accompanying image region in accordance with the divided-region information.

10. An image display apparatus comprising:
a reception unit configured to receive image data including an object image from an image output apparatus which outputs the image data;
a display unit configured to display a display image in accordance with the image data;
a light emission unit configured to be capable of changing light emission brightness corresponding to a plurality of divided regions in the display unit;
a region information reception unit configured to receive background image region information representing a background image region which does not include the object image and accompanying image region information representing an accompanying image region which includes an accompanying image displayed in association with the display image;
a controller configured to control the light emission brightness in the plurality of divided regions in accordance with the background image region information; and
a brightness correction unit configured to correct a brightness value of at least a first portion of the accompanying image included in the background image region in accordance with at least the accompanying image region information.

11. An image output apparatus which transmits image data including an object image to an image display apparatus which displays a display image based on the image data, the image output apparatus comprising:
a first detection unit configured to detect a background image region, which does not include the object image, in the display image;
a second detection unit configured to detect an accompanying image region including an accompanying image displayed in association with the display image;
a region information output unit configured to transmit background image region information representing the background image region and accompanying image region information representing the accompanying image region to the image display apparatus; and
an image data output unit configured to transmit the image data to the image display apparatus.

12. An image display method for displaying a display image including an object image in an image display apparatus, the image display method comprising:
detecting a background image region, which does not include the object image, in the display image;
detecting an accompanying image region including an accompanying image displayed in association with the display image;
displaying the display image in a display unit of the image display apparatus;
controlling the light emission brightness in a plurality of divided regions in the display unit in accordance with the background image region; and
correcting a brightness value of at least a first portion of the accompanying image included in the background image region in accordance with at least the accompanying image region.

13. A computer-readable storage medium storing a program for causing a computer to execute the following steps:
detecting a background image region, which does not include an object image, in a display image including the object image for display on an image display apparatus;
detecting an accompanying image region including an accompanying image displayed in association with the display image;
displaying the display image in a display unit of the image display apparatus;
controlling the light emission brightness in a plurality of divided regions in the display unit in accordance with the background image region; and
correcting a brightness value of at least a first portion of the accompanying image included in the background image region in accordance with at least the accompanying image region.
